(19) United States
(12) Patent Application Publication
(10) Pub. No.: US 2023/0262095 A1
(43) Pub. Date: Aug. 17, 2023

(54) MANAGEMENT OF THE SECURITY OF A COMMUNICATING OBJECT

(71) Applicant: Orange, Issy-Les-Moulineaux (FR)

(72) Inventors: Fabrice Fontaine, Chatillon Cedex (FR); David Armand, Chatillon Cedex (FR)

(21) Appl. No.: 18/002,986

(22) PCT Filed: Jun. 14, 2021
(86) PCT No.: PCT/FR2021/051059

§ 371 Date: Dec. 22, 2022

(30) Foreign Application Priority Data
Jun. 26, 2020 (FR) 2006746

(51) Int. Cl. H04L 9/40; H04L 12/66

(52) U.S. Cl. CPC H04L 63/20; H04L 63/029; H04L 12/66

(57) ABSTRACT

A method for managing a home gateway of a local area communication network. The gateway includes a plurality of components, called sensitive components. The network includes at least one communicating object able to be connected to the network via the gateway. The method includes acquiring at least one security rule relating to at least one interaction of the object with at least one of the components of the gateway; observing at least one interaction of the communicating object with at least one of the components of the gateway; and deciding, on the basis of the observation, on an action on the connected object.

### FIELD OF THE INVENTION

The field of the invention is that of local communication networks, in particular, but not exclusively, home communication networks, comprising an item of access equipment or gateway and a plurality of communicating or connected objects, such as computers, tablets, smartphones, but also cameras of the webcam type, weather stations, sensors, thermostats, etc.

More specifically, the invention relates to the management of a security policy on the gateway of such a local communication network.

### PRIOR ART AND ITS DISADVANTAGES

Currently, when a communicating object is connected in a communication network, and wishes to exchange data on this network, it needs to make itself known to the home gateway. The home gateway particularly assigns the communicating object with an address, which allows it to communicate both on the local network and the external network, and stores some of the features and data of the object. Subsequently, the communications of the object pass through the gateway.

Therefore, the gateway is exposed to a risk: one of these communicating objects can have one or more security fault(s), capable of allowing a malicious individual to enter the local network, and to damage or overload the gateway.

Stipulating security rules for connected objects, in terms of communication, is known. For example, the French patent application published under number FR 3079380 proposes associating a certain number of rules with a connected object that restrict its communication possibilities (blacklist of equipment inaccessible to the object, limitation of the maximum amount of data that can be exchanged on the network, etc.). However, such security rules do not relate to the gateway itself, which remains vulnerable.

Therefore, a requirement exists for a technique for managing the security of a gateway of a local communication network that does not have these various disadvantages of the prior art.

### DISCLOSURE OF THE INVENTION

The invention addresses this requirement by proposing a method for managing a home gateway of a local communication network, said gateway comprising a plurality of components, called sensitive components, said network comprising at least one communicating object able to be connected to said network via the gateway. Such a method comprises, on a management device:
a step of acquiring at least one security rule, relating to at least one interaction of said object with at least one of said components of said gateway;
an observation step involving observing at least one interaction of said communicating object with at least one of said components of said gateway;
a step of deciding, on the basis of said observation, on at least one action on said object.

Thus, the invention is based on a new and inventive approach for managing security rules applied to the equipment, or connected objects, of a local communication network, such as a home network, for example, with the aim of protecting the service gateway.

The principle of this security involves determining, in relation to the connected object, at least one security rule relating to one of the components of the gateway. Thus, subsequently, if this rule is broken, the method can take a protective action by acting on the connected object (warning, rejection, unpairing, etc.).

In other words, the management method “confines” the object, which involves setting up various barrier rules in order to ensure that the object cannot disturb or “contaminate” the sensitive software or hardware components of the gateway, and thereby endanger the gateway itself, the equipment of the local network or the equipment of a wide area network, for example, the service platforms.

This method allows, for example, a malicious object to be prevented from feeding back erroneous data or even too much data that could cause the other services of the gateway to crash by mobilizing its hardware and/or software resources and/or other objects of the network to be reached by installing pirate programs on the gateway.

The invention proposes defining specific security rules for each communicating object, on the basis of the resource requirements of the considered object, of its type, of its level of dangerousness, etc.

The term “connected object” is understood to mean any object or electronic equipment capable of communicating with another object or equipment over a local or wide area network via the gateway. For example, it can be a smartphone, a tablet, a laptop, a thermometer, a camera, a smart plug, etc. Such a connected object comprises a set of associated features, whether it is functions that are performed (giving the time, the temperature, streaming a video stream, etc.) or is manipulated streams, associated with the functions that enter or exit the object (commands, responses, messages, data streams, for example, audiovisual, etc.). Such a connected object uses the resources of the service gateway (memory, processor, data bus, etc.).

The term “local network” is understood to mean a communications network, also called home network hereafter, that connects together, with or without wires, the terminal equipment, or more simply objects (computers, printing peripherals, storage devices, connected objects, etc.) capable of communicating together. A home network comprises a router device, also commonly called a gateway, an intermediate element ensuring redirection, or routing, of the data packets between the various terminals and networks connected thereto. The user of such a network can execute a given service on a given object with specific features (for example, controlling a camera, opening a door, etc.), from its local network (also called LAN) or from a wide area network (also called WAN) via the gateway.

The term “sensitive component of the gateway” is understood to mean a software or hardware element of the gateway: data bus, memory, interface, software program, firmware element, etc.

The term “security rule” is understood to mean a rule that establishes a relationship between the object and such a component, defined by at least one limit. For example, such a rule establishes that a connected object cannot use more than a certain percentage of the processor of the gateway, cannot exchange messages on one of the buses of the gateway beyond a certain throughput or number, cannot use certain programs or interfaces (for example, the USB serial interface, or a WEB server of the gateway), etc.

The term “observation” is understood to mean capturing and measuring the interactions of an object with said components: number of accesses to memory, memory size, percentage use of a processor, access to the interfaces, etc.

The term “action” on an object is understood to mean acting on its operation (transmitting a warning message thereto, blocking its current operation, disconnecting it, rejecting it, unpairing it, pairing it, modifying one of its security rules, etc.).

The term “acquiring the rule” is understood to mean any possible obtaining mode: the security rules can be assigned from a database, or any memory space accessible from the home gateway (network server, hard disk, memory space of the gateway, etc.). Alternatively, the rule can be learned, deduced, computed on the basis of initial data, etc.

According to one embodiment, the method further comprises a step of recording the object in a memory zone, called confinement zone, with the recorded object comprising at least one identification datum of the object and at least one security rule.

Advantageously, according to this embodiment, the object is “virtualized” in a confinement zone that comprises at least one identifier and the security rules associated therewith. This allows the gateway to know, from the identifier, whether the object is confined and to quickly access the security rules.

The term “confinement zone” is understood to mean a memory space in which the confined objects are recorded. This zone may or may not be inside the gateway and may or may not be secure.

The term “identification datum of the object” is understood herein to mean a unique identifier of the object allowing the gateway to uniquely identify it in the local network. It can be its MAC (Media Access Control) address. This MAC address is a physical identifier stored in an interface of the client equipment, for example, its network card. Unless it has been modified by the user of the client equipment, it is unique. It also can be another datum that is specific thereto, for example, an IP address, or a UUID (Universally Unique IDentifier), for example, in the case of a Bluetooth protocol), or an IMSI (International Mobile Subscriber Identity), or an IPUI (International Portable User Identity, unique identifier of the object in the context of the DECT-ULE standard), etc.

According to a variant of this embodiment, the method further comprises a step of removing the object from said confinement memory zone when a deconfinement criterion is met.

Advantageously according to this embodiment, the object that is confined can be deconfined as soon as it is no longer considered necessary for it to be monitored. The term “deconfinement” is understood to mean removing the object from the confinement zone. The record can be erased or moved, or the like. This allows the method to monitor only the objects for which the confinement criterion is not met (since the object is not updated, or has just been connected, or for any other reason that makes it suspicious). The deconfinement criterion thus can correspond to a time interval (or timer), a successful update of software of the object, an increase in the capabilities of the gateway, a modification of its environment, etc.

According to another embodiment, said at least one security rule is acquired after a phase of detecting the connection of said unknown communicating object to said gateway.

Advantageously according to this embodiment, a first phase of acquiring security rules is initiated on detection of the connection of a new communicating object in the network. “Known” is understood to mean that the gateway has already stored at least one identifier of the object. Thus, the unknown object will be able to be rejected quickly if its behavior is not appropriate, which limits the risks for the gateway. Indeed, a known object of the gateway often can be considered to be more reliable than an unknown object.

According to one embodiment, said at least one security rule is acquired via a step of learning the behavior of the object.

Advantageously according to this embodiment, the security rules are assigned after a phase of learning by observation. For example, the connection of the object is accepted, and then the interactions of the communicating object with the components of the gateway are observed over a period of time, in order to deduce therefrom a set of characteristic features of “normal” operation of the communicating object in relation to the gateway. A set of one or more security rule(s) specific to the communicating object, the operation of which has been observed, or common to a type of objects (it can be the same object model in a local network or in a bank of local networks administered by several gateways), then can be created on the basis of these features. This learning phase can have a configurable duration (number of hours, number of days, number of accesses to the components of the gateway, etc.).

According to another embodiment, said at least one security rule is acquired on the basis of a characteristic datum of the object.

Advantageously according to this embodiment, objects of the same type, or same category, or that share common information (for example, feeding back the same type of information, or the same manufacturer, or the same seller, etc.) can be assigned the same security rules. For example, a server can centralize the data for communicating objects of the “camera” type, with a view to sharing them with several gateways from the same manufacturer/operator. For example, all the objects of this type will benefit from the same security rules by default.

According to another embodiment, said at least one security rule associated with said communicating object comprises at least one element from among:
a maximum amount of data that the communicating object is authorized to store in the gateway;
a maximum amount of data that the communicating object is authorized to exchange on one of the data buses of the gateway;
a maximum percentage of use of a processor of the gateway; or
access to a communication module of the gateway;
access to a software module of the gateway.

Advantageously, a rule can be defined that relates to one or more of the sensitive component(s) of the gateway. A communicating object of the temperature sensor type, for example, is intended to store only small amounts of data (records containing the measured temperature, optionally time stamped). It is therefore possible to define a maximum size of the data that the sensor can store, expressed in bytes or in kilobytes. Storing an amount of data in the memory of the gateway that is greater than this maximum amount authorized by the established security rule indicates deviant behavior, or malicious activity. The term “memory” is understood herein to mean a random or read-only, internal or external (hard disk, for example), memory zone of the gateway.

According to another example, when such a communicating object sends a massive number of requests over one of the buses of the gateway this also may indicate deviant behavior, such as participation in a “bornet” attack.

Moreover, such an object is not intended to access the communication modules (for example, the Wi-Fi radio module) or the software programs (for example, the web server) of the gateway.

According to another embodiment, in the event of the detection of an interaction of said communicating object with at least one component contrary to said created security rule, said action on the connected object can be selected from among:
a modification of said at least one security rule;
a step of blocking said interaction;
a rejection of the object;
an unpairing of the object.

Thus, as soon as deviant behavior of the communicating object is observed, which does not correspond to the rules, it can be immediately prohibited, even before it is unpaired, from accessing this component. For example, if malicious behavior is observed, it is possible to act by unpairing a previously paired (associated) object or by rejecting it (an object being paired), but it is also possible to make the rule more stringent (reduce the percentage of use of a processor, the number of accesses to a memory or to a bus, etc.), in order to protect the gateway while maintaining a minimum service (although possibly degraded) for the user.

According to another embodiment, said at least one security rule is assigned a severity index, and the action on the connected object is selected on the basis of this index.

Advantageously, according to this embodiment, provision can be made to classify the rules on the basis of the severity of the infractions that their violation causes (classification into “stringent” rules, the infraction of which is prohibited, or as “flexible” rules that can be adapted, or assignment of priorities to the rules, etc.).

This allows the best action to be taken on the object at a given instant to be determined.

According to one embodiment, said at least one security rule can be modified in the event of the detection of a modification in the context of the home gateway.

Advantageously according to this embodiment, such a method comprises a modification of said created security rule, for example, in the event of the modification of the capabilities of the gateway, of the presence or absence of a user of said communicating object within said local communication network, of the convergence of the object measured by the force of the signal, of the updating of the object, of the operation of the object outside the usual time ranges (example: a camera that feeds back data during the day instead of at night, or vice versa), etc.

The invention also relates to a device for managing a home gateway of a local communication network, said gateway comprising a plurality of components, called sensitive components, said network comprising at least one communicating object able to be connected to said network via the gateway, the device comprising the following modules:
a module for acquiring at least one security rule, relating to at least one interaction of the object with at least one of said components of the gateway;
an observation module observing at least one interaction of said communicating object with at least one of said components of said gateway;
a decision module deciding, on the basis of said observation, on at least one action to be performed on said object.

The invention also relates to a gateway including a management device as described above.

More generally, such a gateway is capable of implementing a local management method as described above.

The invention also relates to a computer program product comprising program code instructions for implementing a management method as described above, when it is executed by a processor.

A further aim of the invention is a computer-readable recording medium, on which a computer program is stored comprising program code instructions for executing the steps of the management method according to the invention as described above.

Such a recording medium can be any entity or device capable of storing the program. For example, the medium can comprise a storage means, such as a ROM, for example, a CD ROM or a microelectronic circuit ROM, or even a magnetic recording means, for example, a USB key or a hard disk. Furthermore, such a recording medium can be a transmissible medium such as an electrical or optical signal, which can be routed via an electrical or optical cable, by radio or by other means, so that the computer program that it contains can be executed remotely. The program according to the invention particularly can be downloaded over a network, for example, the Internet. Alternatively, the recording medium can be an integrated circuit in which the program is incorporated, with the circuit being adapted to execute or to be used to execute the aforementioned management method.

The aforementioned access equipment and the corresponding computer program have at least the same advantages as those provided by the management method according to the present invention.

### LIST OF FIGURES

Further aims, features and advantages of the invention will become more clearly apparent upon reading the following description, which is provided by way of a simple illustrative and non-limiting example, with reference to the figures, in which:

FIG. 1 shows a schematic view of a local communication network and of various communicating objects connected thereto, according to one embodiment of the invention;

FIG. 2 shows a block diagram of an item of access equipment or a home gateway implementing the method of FIG. 3 according to one embodiment of the invention;

FIG. 3 shows a flowchart of the various steps of the management method according to one embodiment of the invention.

### DETAILED DESCRIPTION OF EMBODIMENTS OF THE INVENTION

The general principle of the invention is based on establishing security rules specific to each communicating object of a local communication network with respect to the hardware and/or software components of the service gateway.

The remainder of this document will more specifically focus on describing the implementation of an embodiment of the invention in the context of a home network, in the home of a particular user. Of course, the invention is equally applicable to any other type of local communication network (LAN), to which a plurality of items of communication equipment is connected.

In such a home network, which is schematically shown in FIG. 1, a home gateway 10 allows a local communication network and a wide area network such as the Internet (not shown) to be connected. Such a home gateway 10 particularly integrates a DHCP server: it routes data packets on the network, and can also act as a firewall, proxy, DNS (Domain Name Server) relay, an IGD (Internet Gateway Device) service provider, etc. By way of an example, such a service gateway can be an item of equipment known in France as “box”, such as LiveBox equipment (product marketed by Orange, registered trademark).

It also accesses one or more database(s), from which the security rules specific to each communicating object can be recovered or developed.

In the example of FIG. 1, three connected objects are also shown on the local network: a tablet 14, a webcam 16, a thermostat 15. Naturally, numerous other communicating objects can be present on the local network of the user.

These communicating objects can be connected to the network, via the gateway, via a wired route (Ethernet cable, USB (Universal Serial Bus), etc.), or a wireless route, of the Wi-Fi (Wireless Fidelity), Bluetooth, BLE, Thread, Zigbee (IEEE 802.15.4), Z-Wave, DECT (Digital Enhanced Cordless Telecommunications) and/or DECT ULE (DECT Ultra Low Energy) type. They comprise all types of physical objects capable of digitally communicating on the local network, with a view to exchanging data. They also comprise the software applications associated with some non-IP (Internet Protocol) connected objects, operating on wireless technologies such as BLE (Bluetooth® Low Energy), Z-wave®, Thread®, etc.

Among the communicating objects of FIG. 1, it is possible to conceive that the Internet Access Provider (FAI), which provided the user with the home gateway 10, knows the objects 14 and 15 and can optionally provide the administrator of the local network with predefined security rules for these communicating objects, which could be supplemented and/or refined during a learning phase following their initial connection to the network, or the updating of their firmware. Conversely, other communicating objects such as the webcam 16 can originate from other sources and from other origins: the access provider nevertheless can have data relating to them, such as, for example, their manufacturer, a unique identifier UUID, a name, a type, etc.

In any case, it is important for specific security rules to be able to be established that are applicable to each of these various communicating objects, so as not to damage or overload the gateway. To this end, one embodiment of the invention is based on the flowchart of FIG. 3.

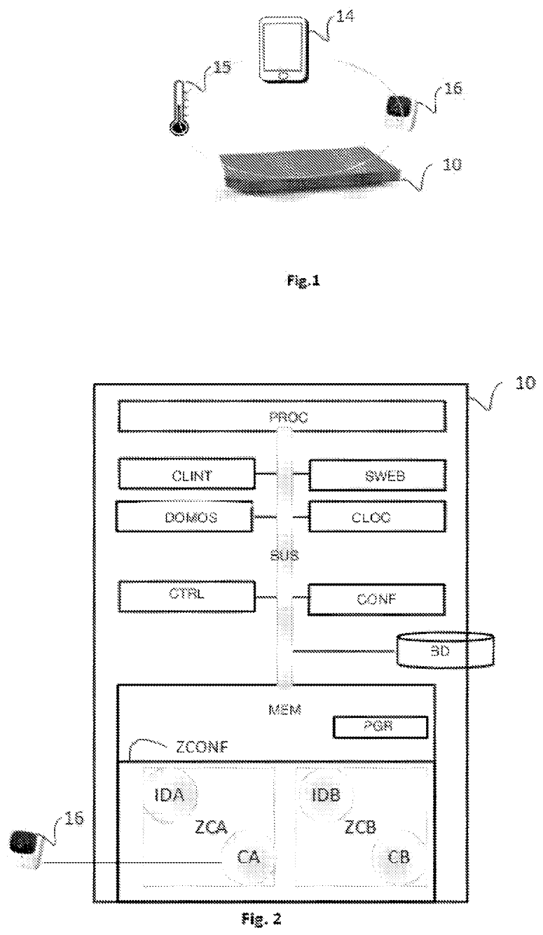

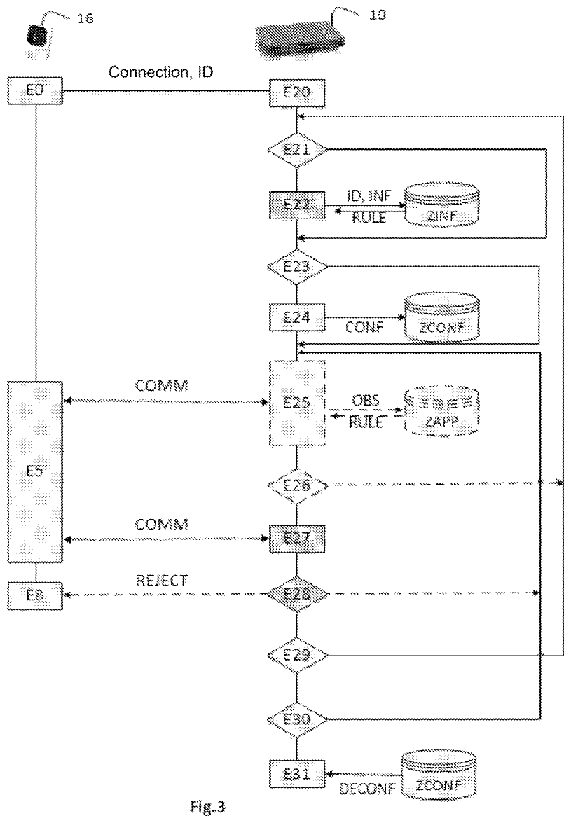

FIG. 2 shows, with reference to FIG. 3, the hardware structure of an item of access equipment, or gateway, according to one embodiment of the invention.

The term “module” can equally correspond to a software component and to a hardware component or a set of hardware and software components, with a software component itself corresponding to one or more computer program(s) or sub-program(s), or more generally to any element of a program capable of implementing a function or a set of functions.

More generally, such a home gateway 10 comprises a memory MEM, a processing unit PROC fitted, for example, with a processor, and driven by a computer program PGR, representing the management method, stored in a read-only memory MEM (for example, a ROM memory or a hard disk). On initialization, the code instructions of the computer program are loaded, for example, into a random-access memory MEM before being executed by the processor of the processing unit.

In the embodiments described with reference to FIG. 2, the gateway 10 further comprises a confinement zone ZCONF. This security zone ZCONF is hosted in the memory MEM. It comprises a data zone for each object, identified by a unique identifier denoted ID. In FIG. 2, the objects A and B corresponding, for example, to two of the connected objects 14-16 of FIG. 1 are shown in their respective zones ZCA and ZCB. Each zone therefore contains:
an identity of the object (unique identifier ID-IDA, IDB) and optionally a set of more specific information (name, type, functions, etc., of the object);
a data zone ZC (ZCA, ZCB) particularly containing all the security rules that are associated with this object in relation to the components of the gateway (maximum percentage of use of one of the buses, of one of the processors, of the memory, etc.);
software, called client communication module (CA, CB), loaded with the links with the connected object on the local network.

According to other embodiments, the client communication module is located outside the confinement zone, and can be shared by several objects.

According to other embodiments, a confinement zone can be shared by several objects that have the same rules.

The processor of the processing unit controls the recording of the data relating to the interactions of the communicating objects with the gateway in the confinement zone ZCONF, using a module denoted CONF and a database BD (which can be internal or external and can be in the form of a hard disk, a server, a memory, etc.). In the secure operating mode, the processor of the processing unit also controls the detection of unusual interactions, their blockage, and the triggering of actions related to the detected security problem, in accordance with the flowchart of FIG. 3, using a module denoted CTRL.

In the embodiments described with reference to FIG. 2, the gateway 10 further comprises a certain number of modules, called “sensitive” modules, i.e., capable of being attacked by one of the objects of the network:
a module CLINT configured for exchanges with the wide area network;
a module CLOC configured for exchanges with the local area network;
a module DOMOS comprising a home automation rules engine, or rules applicable to the connected objects of the local area network;
a web server SWEB.

All these modules conventionally communicate with one another via one or more data buses (BUS). These modules are shown by way of an example. Other software and/or hardware components of the gateway can be considered to be sensitive.

FIG. 2 illustrates only one particular manner, from among several possible manners, of producing the gateway 10, so that it performs the steps of the method described above, with reference to FIG. 2. Indeed, these steps can be equally carried out on a reprogrammable computing machine (a PC computer, a DSP processor or a microcontroller) executing a program comprising a sequence of instructions, or on a dedicated computing machine (for example, a set of logic gates such as an FPGA or an ASIC, or any other hardware module). In the case whereby the home gateway 10 is produced with a reprogrammable computing machine, the corresponding program (i.e., the sequence of instructions) may or may not be stored in a removable storage medium (such as, for example, a diskette, a CD-ROM or a DVD-ROM), with this storage medium being partially or totally readable by a computer or a processor.

The various embodiments are described with reference to a home gateway of the LiveBox® type, but more generally can be implemented in all the gateways, routers, DHCP servers, DECT base stations, and more generally in any network equipment located at the intersection between the communicating object and the wide area communication network.

FIG. 3 shows the various steps of an embodiment of the invention.

It should be noted that the aim of this management method is to place connected objects of the local network whose malicious behaviour can jeopardize the home gateway in a confinement zone, or in quarantine.

To this end, information concerning the object is acquired, and used to obtain or update security rules intended to restrict the malicious capabilities of the object. The object is placed in a confinement zone. Throughout the confinement period, the method forces it to comply with the rules. Afterwards, it can be removed from the confinement zone subject to certain conditions.

The steps of the method according to one embodiment of the invention will now be described.

It should be noted that this embodiment is neither limited to a type of connected object nor to a specific protocol (Wi-Fi, DECT-ULE, Bluetooth, etc.).

During a step E0, the DECT ULE object (16) attempts to communicate with the gateway (10). It can be a connection request, or a pairing request, or more broadly any communication request message.

The gateway receives this request during a step E20, and recovers at least one unique identifier of the object, such as, for example, its MAC address, its IPUI (in the case of a DECT-ULE type protocol) or UUID (in the case of a Bluetooth protocol), or IMSI (in the case of a mobile network) identifier, etc. This identifier is denoted ID in the figure.

Other information concerning the object, denoted INF, can be present in the message, or obtained during step E20, such as, for example, and in a non-limiting manner:
the power of the received signal;
the hardware and/or software version number of the object, or firmware (for example, software version number=1.2.0, hardware number=DT_XXXX, etc.);
its type (smartphone, temperature sensor, door opening detector, electrical plug, button for activating home automation scenarios, etc.);
the methods and/or services exposed by the object, allowing them to be distinguished more precisely (for example, a smart plug of a first type can feedback information concerning its consumption, whereas another plug of the same type can simply indicate its ON/OFF electrical state, a camera can transmit still images or videos, etc.);
an authentication datum used during a prior pairing attempt (for example, on the basis of a low security PIN 0000 or a high security PIN 3535 code);
the number of failed (or successful) attempts to pair the object;
a reference of its manufacturer, its supplier, its seller, etc.

This information can be present in the one or more message(s) transmitted by the connected object, or can be obtained by the gateway via another means (for example, the gateway may have stored information relating to the MAC address of the connected object in its memory, in a database, etc.).

For example, for an object, the method for obtaining the information INF can be as follows:
the gateway recovers the MAC address, the signal power, the IPUI of the object and its software version from the connection request message;
then it accesses a database that provides it with its type, its functions, etc.

In this case, the unique identifier can be, for example, the MAC address and the information INF is made up of the other data.

On completion of this step, on the basis of the information that is obtained, the gateway determines, during a step E21, whether or not the object is to be confined, on the basis of its knowledge of the object.

Indeed, if the gateway knows the object, i.e., it has already recorded at least the identifier (the MAC address, for example) and optionally other information (INF) relating to this object, this means that it may be already paired, or has been paired and then unpaired, etc. In this case, it is already confined, or does not require confinement, in which case step E21 is followed by step E23, which will be described hereafter. However, if the gateway does not know the object, it will assess whether it needs to be confined in accordance with the information and the rules that are obtained, in which case step E21 is followed by step E22.

During a step E22, the management method on the gateway accesses a database (internal or external), denoted ZINF, which can be, for example, in the database BD of FIG. 2, or on an external server, in order to extract at least one rule, denoted RULE, therefrom relating to the object, on the basis of the information, ID and INF. Such rules can be, for example, and in a non-limiting manner:
a limit (maximum percentage) of use of one of the processors of the gateway (main processor, processor of the radio/Wi-Fi module, etc.);
a limit of use of a bus (hardware to the software) of the gateway, in terms of throughput or number of uses;
prohibiting or restricting the use of certain programs or interfaces of the gateway (for example, the communication modules such as the USB interface, or a WEB server, gateway administration programs, etc.);
prohibiting or restricting transmission of certain types of messages (prohibiting or issuing warnings, etc.);
restricting access to security elements (security keys, etc.);
restricting access to one of the memories of the gateway, to avoid violation of sensitive areas or saturation; a malicious object can, for example, overload the memory by attempting to change its MAC address several times and thereby saturate the ARP table of the gateway (the ARP (Address Resolution Protocol) protocol is a standard protocol for recovering the MAC address of a terminal from an IP address);
a commitment to regularly change certain identifiers of the object (in order to comply with, for example, the Privacy mode of the Bluetooth Low Energy (BLE) protocol);
prohibiting installing a software component on the gateway; indeed, simple feedback of data (such as the temperature) by a connected object could be used by an attacker. The attacker could, for example, benefit from this by introducing a malicious software program or malformed data (shell, SQL, web type, etc.) in order to benefit from a fault in the gateway or in the service platforms;
restricting the protocols that can be used by the object if it has several types or versions of protocol; for example, if the Wi-Fi access point of the gateway supports both the TKIP and CCMP encryption protocols, the object has the right to communicate only in CCMP in order to prevent it from exploiting vulnerabilities specific to TKIP; if the Wi-Fi access point of the gateway supports both communications at 2.4 Ghz and 5 Ghz, the object cannot connect to both at once;
etc.

Such a rule can be absolute (for example, not exceeding 5% of use of a processor) or more flexible, with a possibility of modification over time.

The following table shows, by way of an example, some possible rules for a connected object of the camera type (the cited UPnP IGD protocol (Universal Plug and Play Internet Gateway Device) is a network protocol allowing ports to be opened on the gateway so that the camera can be reached from the outside).

TABLE 1
Information obtained (ID, INF)

| Identifiers | Functions | Manipulated streams |
|---|---|---|
| MAC address | Image capture | Image stream |
| Brand XX | Zoom | Zoomed image stream |
| | Time stamping | Video stream |

Rules

| | | |
|---|---|---|
| Prohibiting access to the | Maximum use of the | Prohibiting a video |
| BLE, Zigbee modules, to | processor: 2% | stream (in order to limit |
| the server SWEB | Prohibiting opening of | the use of the processor) |
| | ports on the gateway | |
| | by UPnP IGD. | |

It should be noted that, during this step E22, a new rule can be created, or an existing rule can be modified.

Step E23 involves determining whether or not the object is to be placed in the confinement zone. To this end, a test is carried out to verify that at least one rule has been obtained for the object (if no rule is associated therewith, it does not need to be confined) or if an existing rule has to be modified. If so, it is possible to check whether this rule justifies the confinement (for example, if the gateway is hardly loaded, or if decided by the user, the confinement can be omitted). In this case, step E23 is followed by the communication step E25.

Otherwise, during step E24, the object is recorded in the confinement zone denoted ZCONF in FIG. 2. The confinement zone can be in any memory zone of the gateway (or accessible therefrom) and may or may not be secure. The recording particularly comprises:
an identity of the object (unique identifier ID and/or information INF);
the rules obtained for this object;
optionally, the communication module of the object in the gateway (software module and/or CA/CB hardware module allowing the gateway to communicate with the object, also called “client”). The communication module of the object also can be outside the confinement zone, and optionally shared between several objects.

During the following steps E5, E25, E26 and E27, a “standard” communication is established between the object and the gateway. For example, the camera captures still images and videos and transmits them to the gateway.

During the optional step E25 of learning, the object is observed for the purpose of updating or creating a rule; this is a “dynamic” mode, during which learning is carried out: the object is initially assumed to be “healthy” or “reliable”, then the interactions of the communicating object with the components of the gateway are then observed for a given period of time (for example, a day, a week, etc.) in terms of the nature, the volume and the frequency of any access to the components. The observation data are, according to this example, recorded in a database or memory ZAPP, then analyzed by inductive logic programming, or fuzzy logic, or any other machine learning method in order to deduce therefrom a set of features characteristic of “normal” operation of the communicating object in relation to the gateway. According to the preceding example of the camera, this learning period can correspond to the acquisition of the behaviors of the camera over one day: normal behavior over 24 hours can correspond to 3 triggers of the camera leading to three video streams with an average of 3 seconds with a throughput of 50 kilobits per second. According to another example, a door opening detector can exhibit normal behavior of 40 door openings per day. These “normal” behaviors are used to define rules (RULE) similar to those obtained from step E22. For example, if the camera is triggered 3 times a day, it is possible to prevent it from exceeding 2% of use of the CPU, or to be triggered more than 5 times a day, etc.

In the case of an update, an existing rule can be refined by learning (for example, the initial rule prohibited the object from exceeding 2% of use of the CPU, but a learning observation can allow this percentage to be reduced, etc.).

On completion of this step E25, the generation or modification of one of the rules can be tested during a step E26 and, where appropriate, step E21 can be returned to in order to decide whether the object provided with these new rules has to enter confinement (E21) and to modify, where appropriate, the recording in the confinement zone with the new rule or the modified rule.

During step E27, the object, still communicating with the gateway, is considered to be provided with at least one rule. The object is observed in order to detect illegal behavior if one of these rules is infringed. For example, the program PGR on the home gateway 10 can detect that the camera 16 floods the memory, uses 50% of the CPU, sends inappropriate messages, uses one of the buses excessively, uses the web server, encrypts the hard disk of the gateway, etc.

During the following step, step E28, if the object has infringed a rule, it is considered to be malicious, or at the very least suspicious. An action is then carried out on the object, which can depend on the severity of the infraction: in the case of a serious infraction, this can involve rejection, denoted REJECT in the figure, blocking of the current operation, unpairing, disconnecting the object, generating a warning; in the case of a less serious infraction, a rule can be modified, for example, in order to make it more stringent, etc. To this end, according to a variant, provision can be made to classify the rules on the basis of the severity of the infractions that their violation causes, by assigning a severity index thereto (classification into “stringent” rules with a high index, the infraction of which is prohibited, or as “flexible” rules with a lower index, which can be adapted, or assigning priorities to the rules, etc.). If the object has not infringed a rule, step E28 can be followed by a return to the communication step E25.

Step E28 also can be followed by step E29, during which it is possible to optionally test whether an adaptation of the confinement of the object is essential; indeed, a rule may need to be modified on the basis of a modification criterion. Several criteria can be used, in a non-limiting manner:
infraction of a “flexible” rule observed during step E27/E28;
modification of any information used to generate one of the rules relating to the object (for example, an increase in the capabilities of the gateway, the presence of the user near the connected object, a new certification of the object, etc.);
updating the object; for example, when a new fault is detected on a line of a certain type objects, the rule could be made more stringent in order to limit the risks.

In this case, step E29 is followed by step E21 or step E22, during which the rule will be updated.

Step E29 also can be followed by a step E30, during which it is possible to optionally test whether the object can be removed from the confinement zone. For this test, several confinement criteria can be used, in a non-limiting manner:
assessing a confinement timer (measurement of the elapsed time since the connection of the object);
modifying any information used to generate one of the rules relating to the object (for example, an increase in the capabilities of the gateway, the presence of the user near the connected object, a new certification of the object, etc.);
updating the object; for example, when a new fault is detected on a line of a certain type objects, all the objects of this type could be confined and could be deconfined only once these are updated;
etc.

If this test is negative (the object is not/is no longer confined or it must remain in confinement), step E29 is followed by the communication step E25.

If this test is positive, during step E31, the object can be removed from the confinement zone. For example, the memory zone reserved for the object is moved from the confinement zone to another zone, or the object is erased from the confinement zone, etc. Subsequently, it can re-communicate, for example.

FIG. 3 shows only one particular manner, from among several possible manners, of implementing the management method. Numerous variants can be contemplated.

In particular:
In one embodiment of the invention, it is also possible to unlock the security, or to modify said created security rule, when the presence of an authorized user (for example, the administrator of the home network, or a user whose identifier is duly stored by the home gateway 10) is detected in the home network. Thus, it is possible, for example, to relax the security rules, when the user is detected as being physically present in the local communication network, and therefore to monitor the behavior of its communicating objects. Problems associated with excessively stringent security are thus avoided, which can have a negative impact on the use of the services of the local communication network. According to the techniques of the prior art, the security rules associated with a communicating object are static, unless there is provision to adapt them, for example, to enhance them, if the user is absent from their home. Therefore, it can be advantageous, as previously mentioned, for “flexible” security rules to be provided, which are applied by default when the user is not at home, and for them to be relaxed in order to make them less restrictive when the presence of an authorized user is detected near the communicating object, or in the ecosystem of the local communication network. According to another example, a rule applied to a voice assistant must not be active when no one is at home, it is therefore worthwhile to be able to modify the rules applied thereto.

According to another variant, such a method also comprises recording the blocked interaction in a log of suspicious interactions and/or warning a user of said communicating object. This suspicious interaction log advantageously can be consulted by the user or the administrator of the local communication network. It is also possible that the detection of deviant behavior of a communicating object automatically triggers sending a warning to the user or the administrator of the local communication network, for example, by sending a message thereto. Such a warning also can be triggered when a certain number of suspicious interactions has been stored in the log.

1. A method comprising:
managing a home gateway of a local communication network, said gateway comprising a plurality of components, called sensitive components, said network comprising at least one communicating object able to be connected to said network via the gateway, the managing being performed by a management device and comprising:
observing at least one interaction of said communicating object with at least one of said components of said gateway; and
deciding, on the basis of said observation and on at least one security rule relating to at least one interaction of said object with at least one of said components of said gateway, on at least one action on said object.

2. The method as claimed in claim 1, further comprising recording the object in a memory zone, called confinement zone, comprising at least one identification datum of the object and at least one security rule.

3. The method as claimed in claim 2, further comprising removing the object from said confinement memory zone when a deconfinement criterion is met.

4. The method as claimed in claim 1, further comprising acquiring said at least one security rule after a phase of detecting a connection of said communicating object to said gateway.

5. The method as claimed in claim 1, further comprising acquiring said at least one security rule via a step of learning a behavior of the object.

6. The method as claimed in claim 1, further comprising acquiring said at least one security rule on the basis of a characteristic datum of the object.

7. The method as claimed in claim 1, wherein said at least one security rule associated with said communicating object comprises at least one element from among:
a maximum amount of data that the communicating object is authorized to store in the gateway;
a maximum amount of data that the communicating object is authorized to exchange on one of the data buses of the gateway;
a maximum percentage of use of a processor of the gateway;
access to a communication module of the gateway; or
access to a software module of the gateway.

8. The method as claimed in claim 1, further comprising detecting an interaction of said communicating object with at least one component contrary to said created security rule, and said action on the connected object comprises an action of the group consisting of:
a modification of said at least one security rule;
blocking said interaction;
rejecting the object;
unpairing the object.

9. The method as claimed in claim 1, wherein said at least one security rule is assigned a severity index, and the method comprises selecting the action on the object on the basis of this index.

10. The method as claimed in claim 1, further comprising modifying said at least one security rule in the event of a detection of a modification in a context of the home gateway.

11. A device for managing a home gateway of a local communication network, said gateway comprising a plurality of components, called sensitive components, said network comprising at least one communicating object able to be connected to said network via the gateway, the device comprising:
a processor; and
a non-transitory computer readable medium comprising instructions stored thereon which when executed by the processor configure the device to:
observe at least one interaction of said communicating object with at least one of said components of said gateway; and
decide, on the basis of said observation and on at least one security rule relating to at least one interaction of the object with at least one of said components of the gateway, on at least one action to be performed on said object.

12. A home gateway including the device as claimed in claim 11.

13. A non-transitory computer readable medium comprising a computer program stored thereon comprising instructions which when executed by a processor of a managing device configure the management device to perform a management method comprising:
managing a home gateway of a local communication network, said gateway comprising a plurality of components, called sensitive components, said network comprising at least one communicating object able to be connected to said network via the gateway, the managing comprising:
observing at least one interaction of said communicating object with at least one of said components of said gateway; and
deciding, on the basis of said observation and on at least one security rule relating to at least one interaction of said object with at least one of said components of said gateway, on at least one action on said object.
